(19) United States
(12) Patent Application Publication
(10) Pub. No.: US 2016/0029457 A1
(43) Pub. Date: Jan. 28, 2016

(54) ZIGBEE LIGHTING CONTROL APPARATUS AND METHOD

(71) Applicant: Electronics and Telecommunications Research Institute, Daejeon (KR)

(72) Inventors: Jung-Sik SUNG, Daejeon (KR); Jong-Woo CHOI, Daejeon (KR); Seong-Hee PARK, Daejeon (KR); Hyun-Chul KANG, Daejeon (KR); Hyun-Joo KANG, Daejeon (KR); Tae-Gyu KANG, Daejeon (KR)

(21) Appl. No.: 14/710,867

(22) Filed: May 13, 2015

(30) Foreign Application Priority Data
Jul. 25, 2014 (KR) 10-2014-0094534

(51) Int. Cl. H05B 37/02; H04W 76/00; H04W 48/10

(52) U.S. Cl. CPC H05B 37/02; H04W 48/10; H04W 76/002

(57) ABSTRACT

Disclosed herein are a Zigbee lighting control apparatus and method. The Zigbee lighting control method includes checking whether a Zigbee switch to which a Zigbee lighting control apparatus is applied is in a reset state, performing a broadcast-based link connection a number of times identical to a number of currently installed Zigbee lighting devices if the Zigbee switch is in the reset state, performing a broadcast-based link connection a number of times identical to a preset number of Zigbee lighting devices if it is checked that the Zigbee switch is not in the reset state, performing a unicast-based link connection on remaining Zigbee lighting devices that are not connected to a link, among Zigbee lighting devices within a preset range upon performing the broadcast-based link connection, and controlling Zigbee lighting devices that have been connected via the broadcast-based link connection or the unicast-based link connection.

### CROSS REFERENCE TO RELATED APPLICATION

This application claims the benefit of Korean Patent Application No. 10-2014-0094534 filed Jul. 25, 2014, which is hereby incorporated by reference in its entirety into this application.

### BACKGROUND OF THE INVENTION

1. Technical Field

The present invention generally relates to a Zigbee lighting control apparatus and method and, more particularly, to an apparatus and method that control multiple Zigbee wireless lighting devices using a broadcast-based link connection and a unicast-based link connection when a Zigbee touchlink procedure is performed based on a Zigbee Light Link (ZLL) in a Zigbee switch or a Zigbee touch pad.

2. Description of the Related Art

Generally, as communication technology for controlling lighting devices, communication using infrared Data Association (IrDA), wireless communication using radio frequencies (RF) such as Zigbee, Bluetooth or wireless Local Area Network (WLAN), and wired communication based on a bus, such as a Digital Multiplex 512 (DMX512) bus, a power line, or a Controller Area Network (CAN) bus, have been used.

Such Zigbee wireless communication technology, for example, Korean Patent Application Publication No. 10-2012-0000146 entitled “Lighting Control System using Zigbee Wireless Communication”, describes technology in which a Zigbee module is provided in a main controller mounted on a wall surface, and a Zigbee lighting device equipped with a Zigbee module is controlled in a Zigbee wireless manner only by a user authorized via user recognition.

In this way, Zigbee wireless communication technology may be implemented based on not only a connection to a Zigbee link, but also a connection to a Zigbee Light Link (ZLL)-based Zigbee link.

ZLL denotes standardization technology for controlling lighting using Zigbee, and connects a Zigbee link via a ZLL touchlink procedure using a ZLL commissioning scheme, rather than connecting a Zigbee link using Zigbee commissioning technology.

A ZLL touchlink supports a connection to a Zigbee light link using a method of registering a single Zigbee lighting device having a highest received signal strength indication (RSSI) value among multiple responding Zigbee lighting devices by utilizing broadcast scanning. In this case, even if a Zigbee lighting device having the highest RSSI value is identical to an existing lighting device, a connection to the corresponding Zigbee link is established. Thus, a problem arises in that a great delay occurs in a link connection.

### SUMMARY OF THE INVENTION

Accordingly, the present invention has been made keeping in mind the above problems occurring in the prior art, and an object of the present invention is to provide an apparatus and method that control multiple Zigbee wireless lighting devices using broadcast-based link connection and unicast-based link connection when a Zigbee touchlink procedure is performed based on a ZigBee Light Link (ZLL) in a Zigbee switch or a Zigbee touch pad.

More specifically, when the present invention performs a link connection via a ZLL touchlink procedure, a Zigbee lighting device to which a link connection has already been established does not send a response when a broadcast scanning request for a ZLL touchlink is received, thus reducing a delay in a link connection. Further, all Zigbee lighting devices may not be connected using only a broadcast scanning request. Therefore, the present invention is intended to provide technology for reducing a link connection time upon connecting a large-capacity Zigbee lighting device using a unicast-based link connection technique, together with a broadcast scanning request.

In accordance with an aspect of the present invention to accomplish the above object, there is provided a Zigbee lighting control method, including checking whether a Zigbee switch to which a Zigbee lighting control apparatus is applied is in a reset state; performing a broadcast-based link connection a number of times identical to a number of currently installed Zigbee lighting devices if it is checked that the Zigbee switch is in the reset state; performing a broadcast-based link connection a number of times identical to a preset number of Zigbee lighting devices if it is checked that the Zigbee switch is not in the reset state; performing a unicast-based link connection on remaining Zigbee lighting devices that are not connected to a link, among Zigbee lighting devices within a preset range upon performing the broadcast-based link connection; and controlling Zigbee lighting devices that have been connected via the broadcast-based link connection or the unicast-based link connection.

Performing the broadcast-based link connection may include sending, by the Zigbee lighting control apparatus, a scan request message to multiple Zigbee lighting devices; receiving scan response messages from one or more Zigbee lighting devices that receive the scan request message; selecting a Zigbee lighting device, from which a scan response message having a highest received signal strength indication (RSSI) value, from among the scan response messages, is sent; sending a device information request message to the selected Zigbee lighting device, and receiving a device information response message in response to the request message; updating table information using device information included in the device information response message, and mapping an ID and a network address of the selected Zigbee lighting device to each other; and performing a network initiation procedure with the selected Zigbee lighting device.

Receiving the scan response messages may include receiving scan response messages from Zigbee lighting devices for which a link connection to the Zigbee switch is not currently established, among Zigbee lighting devices that receive the scan request message.

The Zigbee lighting control method may further include if a link connection to the selected Zigbee lighting device has been completed via the network initiation procedure, receiving an ON/OFF state value and a current level value of the selected Zigbee lighting device from the selected Zigbee lighting device; and changing a color of an icon of the selected Zigbee lighting device to a specific color using the ON/OFF state value and the current level value of the selected Zigbee lighting device, and displaying a state of the Zigbee lighting device.

Performing the unicast-based link connection may include previously registering a network address of each Zigbee lighting device and determining whether the network address is statically mapped to an ID of the Zigbee lighting device; if Zigbee lighting devices that are not connected to a link are present among Zigbee lighting devices, network addresses and IDs of which are mapped to each other, performing a unicast-based link connection a number of times identical to a number of Zigbee lighting devices that are not connected; and if a Zigbee lighting device, a network address and an ID of which are mapped to each other, is not present, determining whether Zigbee lighting devices from which the link is disconnected are present among Zigbee lighting devices that have been previously connected to the link, and performing a unicast-based link connection a number of times identical to a number of Zigbee lighting devices from which the link is disconnected.

Performing the unicast-based link connection may further include sending a scan request message using network addresses of the Zigbee lighting devices that are not connected to the link; receiving a scan response message from each Zigbee lighting device that receives the scan request message; sending a device information request message to the Zigbee lighting device that sent the scan response message, and receiving a device information response message in response to the device information request message; and updating table information using device information included in the device information response message, and performing a network initiation procedure with the Zigbee lighting device.

The Zigbee lighting control method may further include, if a link connection to the Zigbee lighting device has been completed via the network initiation procedure, receiving an ON/OFF state value and a current level value of the Zigbee lighting device from the Zigbee lighting device; and changing a color of an icon of the Zigbee lighting device to a specific color using the ON/OFF state value and the current level value of the Zigbee lighting device, and displaying a state of the Zigbee lighting device.

Sending the scan request message may include sending the scan request message, and resending the scan request message if the scan response message is not received; and if a scan response message is not received in response to the resent scan request message, determining that a fault has occurred in the Zigbee lighting device, changing a color of an icon of the Zigbee lighting device to another preset color, and displaying a state of the Zigbee lighting device.

In accordance with another aspect of the present invention to accomplish the above object, there is provided a Zigbee lighting control apparatus, including a display unit for displaying icons respectively indicating states of multiple Zigbee lighting devices; a touchlink unit for determining whether to perform a Zigbee Light Link (ZLL) touchlink procedure; and a control unit for controlling Zigbee lighting devices by checking whether a Zigbee switch is in a reset state depending on results of determination by the touchlink unit, performing a broadcast-based link connection on a corresponding Zigbee lighting device based on results of the checking, and performing a unicast-based link connection on remaining Zigbee lighting devices that are not connected via the broadcast-based link connection.

The control unit may be configured to perform a broadcast-based link connection a number of times identical to a number of currently installed Zigbee lighting devices if the Zigbee switch is in the reset state, and to perform a broadcast-based link connection a number of times identical to a preset number of Zigbee lighting devices if the Zigbee switch is not in the reset state.

The control unit may send a scan request message to the multiple Zigbee lighting devices, receive scan response messages from one or more Zigbee lighting devices that receive the scan request message, select a Zigbee lighting device, from which a scan response message having a highest received signal strength indication (RSSI) value, from among the scan response messages, is sent, and perform a network initiation procedure with the selected Zigbee lighting device.

The control unit may receive scan response messages from Zigbee lighting devices for which a link connection to the Zigbee switch is not currently established, among Zigbee lighting devices that receives the scan request message.

The control unit may be configured to, if a link connection to the selected Zigbee lighting device has been completed via the network initiation procedure, receive an ON/OFF state value and a current level value of the selected Zigbee lighting device from the selected Zigbee lighting device, change a color of an icon of the selected Zigbee lighting device to a specific color using the ON/OFF state value and the current level value of the selected Zigbee lighting device, and display a state of the Zigbee lighting device.

The control unit may be configured to previously register a network address of each Zigbee lighting device and determine whether the network address is statically mapped to an ID of the Zigbee lighting device; if Zigbee lighting devices that are not connected to a link are present among Zigbee lighting devices, network addresses and IDs of which are mapped to each other, perform a unicast-based link connection a number of times identical to a number of Zigbee lighting devices that are not connected; and if a Zigbee lighting device, a network address and an ID of which are mapped to each other, is not present, determine whether Zigbee lighting devices from which a link is disconnected are present among Zigbee lighting devices that have been previously connected to the link, and perform a unicast-based link connection a number of times identical to a number of Zigbee lighting devices from which the link is disconnected.

The control unit may be configured to send a scan request message using network addresses of the Zigbee lighting devices that are not connected to the link upon performing the unicast-based link connection; receive a scan response message from each Zigbee lighting device that receives the scan request message; and then perform a network initiation procedure with the Zigbee lighting device that sent the scan response message.

The control unit may be configured to, if a link connection to the Zigbee lighting device has been completed via the network initiation procedure, receive an ON/OFF state value and a current level value of the Zigbee lighting device from the Zigbee lighting device, change a color of an icon of the Zigbee lighting device to a specific color using the ON/OFF state value and the current level value of the Zigbee lighting device, and display a state of the Zigbee lighting device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an environment to which a Zigbee lighting control apparatus according to an embodiment of the present invention is applied;

FIG. 2 is a configuration diagram schematically showing a Zigbee lighting control apparatus according to an embodiment of the present invention;

FIG. 3 is a flowchart showing a Zigbee lighting control method according to an embodiment of the present invention;

FIG. 4 is a flowchart showing a broadcast-based link connection procedure upon performing a ZLL touchlink procedure according to an embodiment of the present invention;

FIG. 5 is a flowchart showing a unicast-based link connection procedure upon performing a ZLL touchlink procedure according to an embodiment of the present invention; and

FIG. 6 is a diagram showing a Zigbee lighting control apparatus for controlling a Zigbee lighting device for which a link connection has been completed via a ZLL touchlink procedure according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, a Zigbee lighting control apparatus and method according to preferred embodiments of the present invention will be described in detail with reference to the attached drawings.

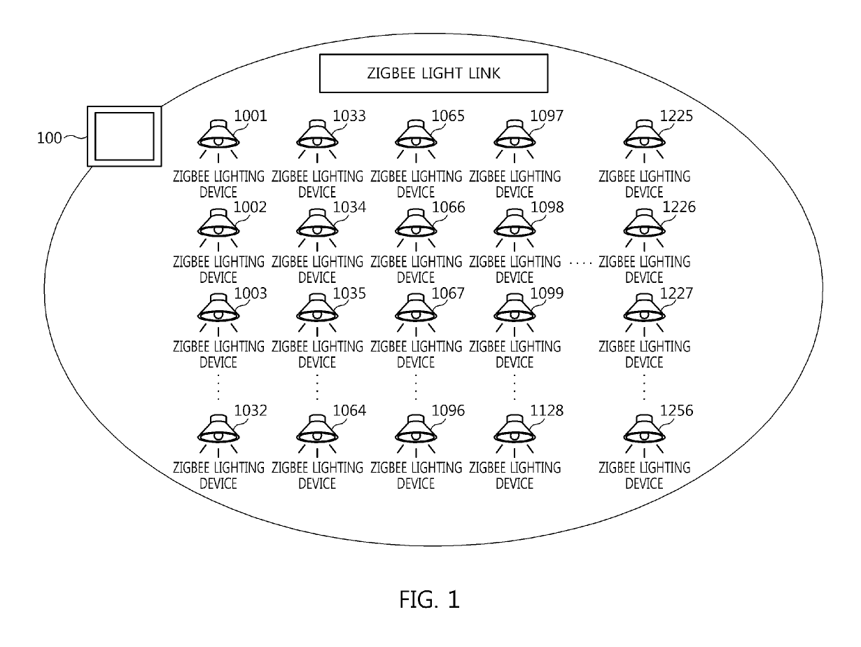

FIG. 1 is a diagram showing an environment to which a Zigbee lighting control apparatus according to an embodiment of the present invention is applied.

First, a Zigbee lighting control apparatus 100 according to an embodiment of the present invention may be applied to a Zigbee switch or a Zigbee touch pad, but is not limited thereto.

Referring to FIG. 1, the Zigbee lighting control apparatus 100 controls multiple Zigbee lighting devices 1001 to 1256 based on a ZigBee Light Link (ZLL).

The Zigbee lighting control apparatus 100 may connect a link by performing a ZLL touchlink on each of the Zigbee lighting devices 1001 to 1256, and thereafter control each Zigbee lighting device.

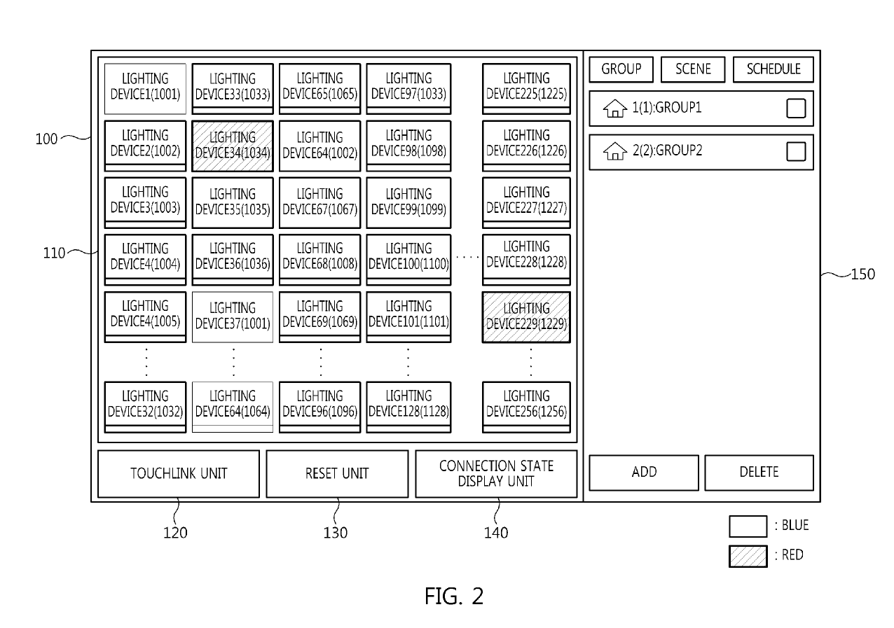

Below, with reference to FIG. 2, the Zigbee lighting control apparatus 100 will be described in detail.

FIG. 2 is a configuration diagram schematically showing a Zigbee lighting control apparatus according to an embodiment of the present invention.

Referring to FIG. 2, a Zigbee lighting control apparatus 100 includes a display unit 110 for displaying respective states of multiple Zigbee lighting devices 1001 to 1256, a touchlink unit 120, a reset unit 130, a connection state display unit 140, and a control unit 150.

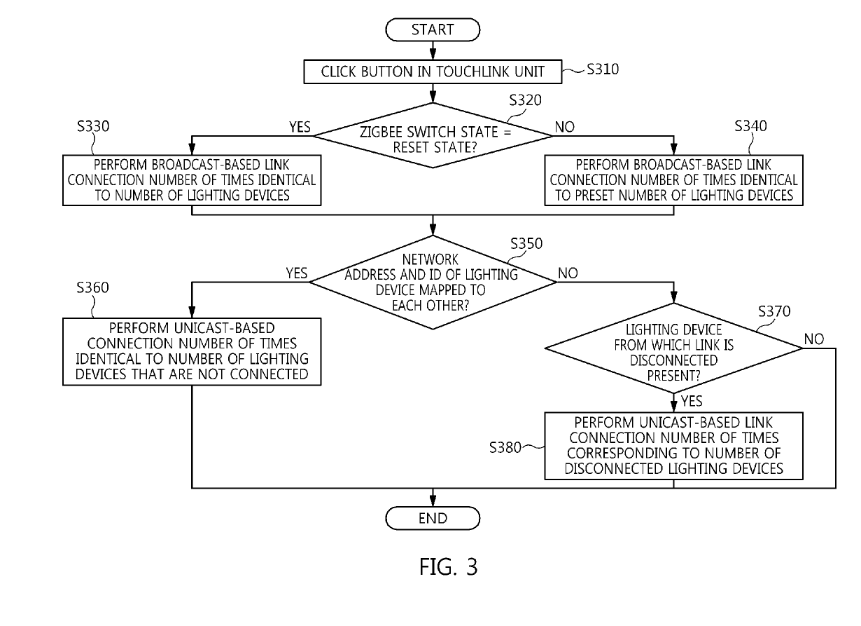

First, the Zigbee lighting control apparatus 100 is configured such that, when a user clicks a button included in the touchlink unit 120 to perform a ZLL touchlink, the ZLL touchlink is performed once if the number of currently installed Zigbee lighting devices is not known, whereas the ZLL touchlink is performed in a manner shown in FIG. 3 if the number of currently installed Zigbee lighting devices is known.

FIG. 2 is illustrated on the assumption that the Zigbee lighting control apparatus 100 recognizes that 256 lighting devices (multiple Zigbee lighting devices 1001 to 1256) are installed.

The connection state display unit 140 displays the number of lighting devices that have been connected to date whenever a link connection succeeds when the user clicks a button included in the touchlink unit 120.

The display unit 110 displays the respective states of the 256 lighting devices, changes the color of icons of lighting devices that are currently connected to a Zigbee link (or link) to blue to indicate that the lighting devices have been connected to the Zigbee link, and then indicates the icons of the remaining lighting devices that are not connected to the Zigbee link in an original color, that is, gray. In this case, indicating the icons of the lighting devices connected to the Zigbee link in blue or indicating the icons of lighting devices that are not connected to the Zigbee link in gray on the display unit 110 may vary depending on the settings, and is not limited to specific settings.

After a link connection has been established via the ZLL touchlink, the display unit 110 may acquire state information from Zigbee lighting devices that have been connected to the link, and display the ON/OFF state values and dimming values of the lighting devices below the icons of the lighting devices.

After the ZLL touchlink has succeeded, the display unit 110 is configured such that, for the icon of each lighting device indicated in blue, when responses are not received several times from the lighting device upon performing lighting control, it is determined that a link to the corresponding lighting device is disconnected, and the icon of the lighting device is indicated in red.

The reset unit 130 releases and initializes connections to all currently connected links in response to a user's request, for example, by the user clicking a reset button included in the reset unit 130.

In addition to individual control of the 256 lighting devices (multiple Zigbee lighting devices 1001 to 1256), the control unit 150 performs group-based control, scene control, scheduling control, or the like on the lighting devices.

More specifically, the control unit 150 may add or delete a group, scene, or scheduling ID. Further, the control unit 150 supports a function of, when a group is added, dragging the icons of the lighting devices 1001 to 1256 and adding the icons to the corresponding group, thus allowing the lighting devices to be members of the group. Further, in the case of scene control, the control unit 150 supports such a function so that scene control is operated in the same manner as the group-based control.

Below, a method for controlling Zigbee lighting by performing a ZLL touchlink in such a way that a user clicks a button included in the touchlink unit 120 will be described in detail with reference to FIG. 3.

FIG. 3 is a flowchart showing a Zigbee lighting control method according to an embodiment of the present invention.

The Zigbee lighting control apparatus 100 according to an embodiment of the present invention may be applied to a Zigbee switch or a Zigbee touch pad, and is not limited thereto.

Referring to FIG. 3, the Zigbee lighting control apparatus 100 recognizes that the user clicks a button included in the touchlink unit 120 at step S310.

When the button included in the touchlink unit 120 is clicked, the Zigbee lighting control apparatus 100 checks whether the Zigbee switch is in a reset state at step S320.

If the Zigbee switch is in the reset state, the Zigbee lighting control apparatus 100 performs a broadcast-based link connection a number of times identical to the number of currently installed lighting devices at step S330.

If the Zigbee switch is not in the reset state, the Zigbee lighting control apparatus 100 performs a broadcast-based link connection a number of times identical to the preset number of times, for example, a number of times less than the number of installed lighting devices, at step S340.

If links to all Zigbee lighting devices falling within a preset range have been connected in the broadcast-based link connection at step S330 or S340, the Zigbee lighting control apparatus 100 no longer performs a link connection, and terminates the ZLL touchlink procedure, otherwise it performs the following operations.

The Zigbee lighting control apparatus 100 previously registers the network address of each Zigbee lighting device, and checks whether the network address is statically mapped to the ID of the corresponding Zigbee lighting device at step S350.

If there are lighting devices that are not connected to the link, among Zigbee lighting devices, the network addresses and IDs of which are mapped to each other, the Zigbee lighting control apparatus 100 performs a unicast-based link connection a number of times identical to the number of lighting devices that are not connected at step S360.

If there is no Zigbee lighting device, the network address and ID of which are mapped to each other, the Zigbee lighting control apparatus 100 determines whether Zigbee lighting devices from which a link is disconnected are present among lighting devices that have been previously connected to the link at step S370.

If it is determined that the Zigbee lighting devices from which a link is disconnected are present among the lighting devices that have been previously connected to the link, the Zigbee lighting control apparatus 100 performs a unicast-based link connection a number of times identical to the number of the disconnected lighting devices at step S380.

In this way, the Zigbee lighting control apparatus 100 may connect all available Zigbee lighting devices by the user clicking a button included in the touchlink unit 120. Here, if all of the installed Zigbee lighting devices have not yet been connected, the user again clicks the button, so that a link connection procedure may be performed on the remaining Zigbee lighting devices.

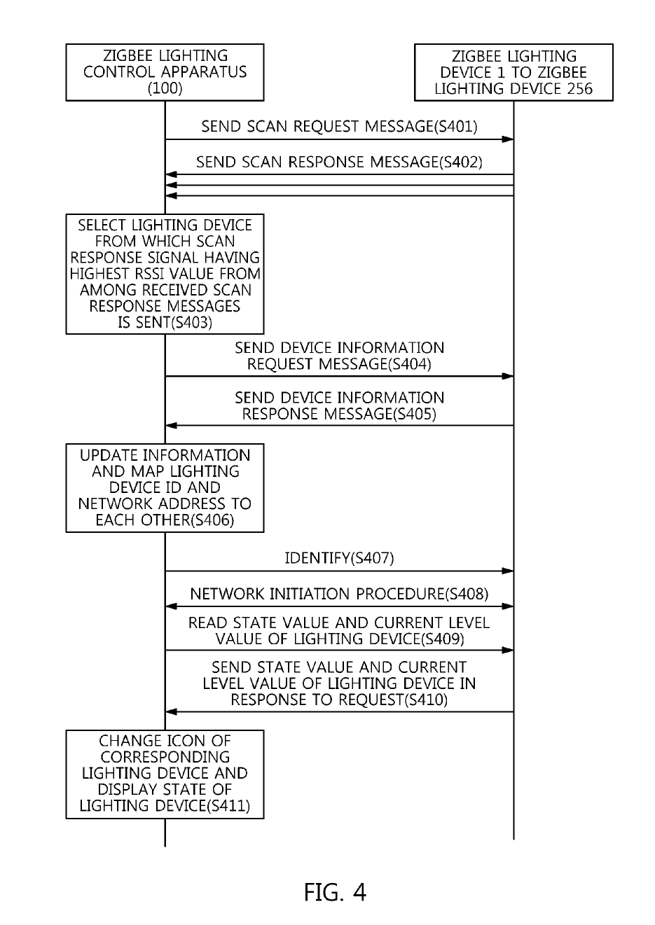

Below, a broadcast-based link connection procedure upon performing a ZLL touchlink procedure in FIG. 3 will be described in detail with reference to FIG. 4.

FIG. 4 is a flowchart showing a broadcast-based link connection procedure upon performing a ZLL touchlink procedure according to an embodiment of the present invention.

First, the Zigbee lighting control apparatus 100 controls Zigbee lighting device 1 to Zigbee lighting device 256 (1001 to 1256) (hereinafter also referred to as “multiple Zigbee lighting devices”) by performing a ZLL touchlink connection procedure in such a way that the user clicks a button included in the touchlink unit 120.

Referring to FIG. 4, the Zigbee lighting control apparatus 100 sends a broadcast scan request message to the multiple Zigbee lighting devices at step S401.

The Zigbee lighting devices, which received the broadcast scan request message, send scan response messages to the Zigbee lighting control apparatus 100 at step S402. At step S402, all of the Zigbee lighting devices, which received the broadcast scan request message, do not send the response messages. That is, among the Zigbee lighting devices that receive the broadcast scan request message, only Zigbee lighting devices, for which a link connection to the Zigbee switch is not currently established, send scan response messages to the Zigbee lighting control apparatus 100.

The Zigbee lighting control apparatus 100 selects a Zigbee lighting device from which a scan response message having a highest RSSI value from among the received scan response messages has been sent at step S403.

The Zigbee lighting control apparatus 100 sends a device information request message to the Zigbee lighting device, selected at step S403, at step S404. The Zigbee lighting device sends a device information response message to the Zigbee lighting control apparatus 100 at step S405.

Even if device information included in the device information response message received at step S405 is stored in a link connection table, the Zigbee lighting control apparatus 100 updates table information, and maps the ID and the network address of the lighting device to each other at step S406.

Then, the Zigbee lighting control apparatus 100 identifies the selected Zigbee lighting device at step S407, and performs a network initiation procedure with the selected Zigbee lighting device at step S408.

In this way, if the link connection to the selected Zigbee lighting device has been completed, the Zigbee lighting control apparatus 100 requests the ON/OFF state value and current level value of the selected Zigbee lighting device from the lighting device at step S409, and receives responses for the ON/OFF state value and current level value of the selected Zigbee lighting device in response to the request at step S410.

Thereafter, the Zigbee lighting control apparatus 100 changes the color of the icon of the lighting device to blue using the ON/OFF state value and current level value of the lighting device received at step S410, and displays the state of the lighting device at step S411.

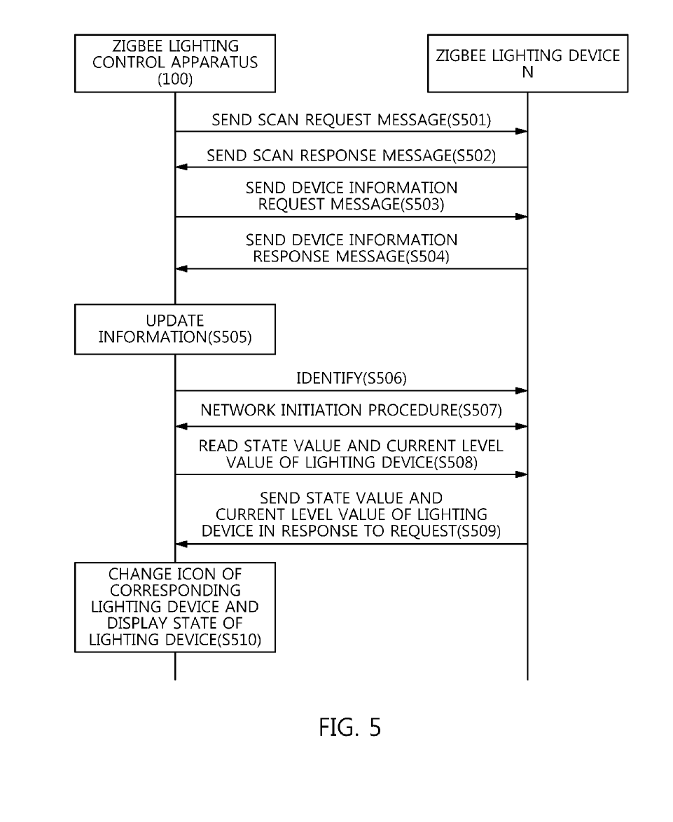

Below, a unicast-based link connection procedure upon performing a ZLL touchlink procedure in FIG. 3 will be described in detail with reference to FIG. 5.

FIG. 5 is a flowchart showing a unicast-based link connection procedure upon performing a ZLL touchlink procedure according to an embodiment of the present invention.

First, the Zigbee lighting control apparatus 100 controls a Zigbee lighting device n that is not currently connected to a link, among Zigbee lighting devices, the network addresses and IDs of which are mapped to each other, and then performs a unicast-based link connection on the Zigbee lighting device n.

Referring to FIG. 5, if the ID of a Zigbee lighting device that is not currently connected to the link is present, among IDs of Zigbee lighting devices, the network addresses and IDs of which are mapped to each other, the Zigbee lighting control apparatus 100 acquires the network address of the Zigbee lighting device, and sends a unicast scan request message to the Zigbee lighting device using the corresponding network address at step S501.

The Zigbee lighting device that receives the unicast scan request message sends a scan response message to the Zigbee lighting control apparatus 100 if communication is enabled at step S502.

The Zigbee lighting control apparatus 100 sends a device information request message to the Zigbee lighting device that sent the scan response message at step S503. Next, the Zigbee lighting device sends a device information response message to the Zigbee lighting control apparatus 100 at step S504.

The Zigbee lighting control apparatus 100 updates table information even if device information included in the device information response message received at step S504 is stored in a link connection table at step S505. Here, since the ID and network address of the Zigbee lighting device have been mapped to each other, a mapping procedure thereof will be omitted.

Thereafter, the Zigbee lighting control apparatus 100 identifies the Zigbee lighting device at step S506, and performs a network initiation procedure with the Zigbee lighting device at step S507.

In this way, if the link connection to a single Zigbee lighting device has been completed, the Zigbee lighting control apparatus 100 requests the ON/OFF state value and current level value of the Zigbee lighting device from the Zigbee lighting device at step S508, and receives responses for the ON/OFF state value and current level value of the Zigbee lighting device in response to the request at step S509.

Then, the Zigbee lighting control apparatus 100 changes the color of the icon of the lighting device to blue using the ON/OFF state value and the current level value, received at step S509, and displays the state of the lighting device at step S510.

The Zigbee lighting control apparatus 100 sends a unicast scan request message as in the case of step S501, and if a scan response message is not received, resends the same message, that is, the unicast scan request message. In this case, if a scan response message is not received in response to the resent unicast scan request message, the Zigbee lighting control apparatus 100 determines that a fault has occurred in the Zigbee lighting device, changes the color of the icon of the Zigbee lighting device to red, and displays the Zigbee lighting device.

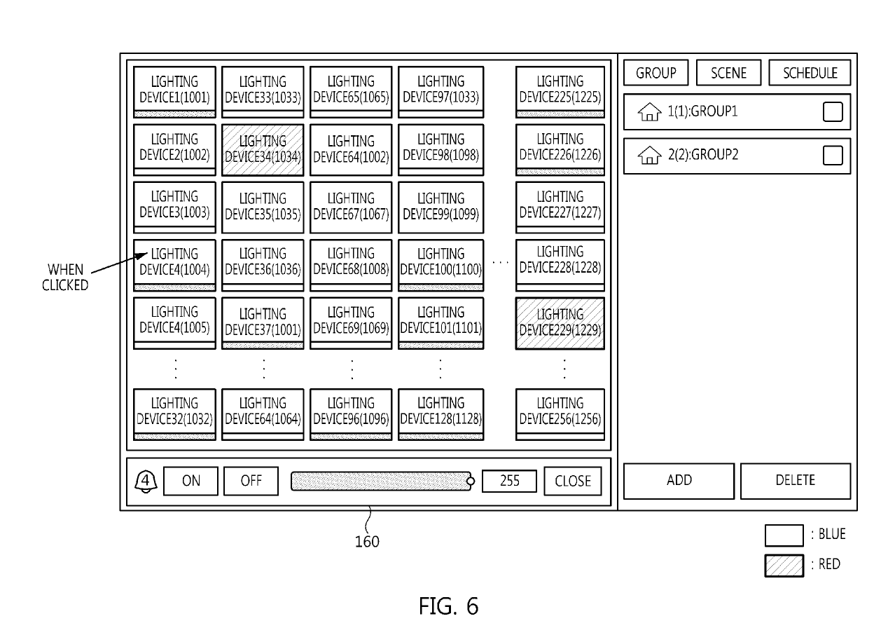

Below, the Zigbee lighting control apparatus for controlling a Zigbee lighting device, for which a link connection has been completed via a ZLL touchlink procedure, will be described in detail with reference to FIG. 6.

FIG. 6 is a diagram showing a Zigbee lighting control apparatus for controlling a Zigbee lighting device, for which a link connection has been completed via a ZLL touchlink procedure, according to an embodiment of the present invention.

First, the Zigbee lighting control apparatus 100 shown in FIG. 6 may be represented by a screen corresponding to a case where the Zigbee lighting control apparatus 100 of FIG. 2 completes a link connection via a ZLL touchlink procedure. When the user clicks the icon of a certain Zigbee lighting device, the corresponding Zigbee lighting device may be individually controlled.

Referring to FIG. 6, the Zigbee lighting control apparatus 100 completes a link connection via the ZLL touchlink procedure by the user clicking a button included in the touchlink unit 120, and further includes a control bar 160 for performing control such that, when the user clicks a lighting device icon corresponding to, for example, lighting device 4 (1004), the lighting device 4 (1004) may be individually controlled.

When the user clicks an ON button, the Zigbee lighting control apparatus 100 delivers a ZLL ON command to the lighting device 4, thus turning on the lighting device 4. Next, the Zigbee lighting control apparatus 100 receives the ON/OFF state and the current level value of the lighting device 4 from the lighting device 4, and displays the state of the lighting device by means of the received values.

As described above, the present invention may reduce a delay in the link connection of Zigbee lighting devices in a single Zigbee switch or Zigbee touch pad, thus connecting and controlling the large-capacity Zigbee lighting devices within a short period of time.

In accordance with the present invention, the Zigbee lighting control apparatus and method are advantageous in that a delay in the link connection of Zigbee lighting devices is reduced in a single Zigbee switch or Zigbee touch pad, thus connecting and controlling the large-capacity Zigbee lighting devices within a short period of time.

Further, unlike conventional technology in which missing lighting devices were present when a large number of lighting devices are connected to a Zigbee link via Zigbee wireless communication, the present invention is advantageous in that a lighting device that has been connected at least once may be connected to the Zigbee link as long as a fault does not occur in the lighting device, thus improving reliability upon controlling lighting devices via Zigbee wireless communication.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A Zigbee lighting control method, comprising:
checking whether a Zigbee switch to which a Zigbee lighting control apparatus is applied is in a reset state;
performing a broadcast-based link connection a number of times identical to a number of currently installed Zigbee lighting devices if it is checked that the Zigbee switch is in the reset state;
performing a broadcast-based link connection a number of times identical to a preset number of Zigbee lighting devices if it is checked that the Zigbee switch is not in the reset state;
performing a unicast-based link connection on remaining Zigbee lighting devices that are not connected to a link, among Zigbee lighting devices within a preset range upon performing the broadcast-based link connection; and
controlling Zigbee lighting devices that have been connected via the broadcast-based link connection or the unicast-based link connection.

2. The Zigbee lighting control method of claim 1, wherein performing the broadcast-based link connection comprises:
sending, by the Zigbee lighting control apparatus, a scan request message to multiple Zigbee lighting devices;
receiving scan response messages from one or more Zigbee lighting devices that receive the scan request message;
selecting a Zigbee lighting device, from which a scan response message having a highest received signal strength indication (RSSI) value, from among the scan response messages, is sent;
sending a device information request message to the selected Zigbee lighting device, and receiving a device information response message in response to the request message;
updating table information using device information included in the device information response message, and mapping an ID and a network address of the selected Zigbee lighting device to each other; and
performing a network initiation procedure with the selected Zigbee lighting device.

3. The Zigbee lighting control method of claim 2, wherein receiving the scan response messages comprises:
receiving scan response messages from Zigbee lighting devices for which a link connection to the Zigbee switch is not currently established, among Zigbee lighting devices that receive the scan request message.

4. The Zigbee lighting control method of claim 2, further comprising:
if a link connection to the selected Zigbee lighting device has been completed via the network initiation procedure, receiving an ON/OFF state value and a current level value of the selected Zigbee lighting device from the selected Zigbee lighting device; and
changing a color of an icon of the selected Zigbee lighting device to a specific color using the ON/OFF state value and the current level value of the selected Zigbee lighting device, and displaying a state of the Zigbee lighting device.

5. The Zigbee lighting control method of claim 1, wherein performing the unicast-based link connection comprises:
previously registering a network address of each Zigbee lighting device and determining whether the network address is statically mapped to an ID of the Zigbee lighting device;
if Zigbee lighting devices that are not connected to a link are present among Zigbee lighting devices, network addresses and IDs of which are mapped to each other, performing a unicast-based link connection a number of times identical to a number of Zigbee lighting devices that are not connected; and
if a Zigbee lighting device, a network address and an ID of which are mapped to each other, is not present, determining whether Zigbee lighting devices from which the link is disconnected are present among Zigbee lighting devices that have been previously connected to the link, and performing a unicast-based link connection a number of times identical to a number of Zigbee lighting devices from which the link is disconnected.

6. The Zigbee lighting control method of claim 5, wherein performing the unicast-based link connection further comprises:
sending a scan request message using network addresses of the Zigbee lighting devices that are not connected to the link;
receiving a scan response message from each Zigbee lighting device that receives the scan request message;
sending a device information request message to the Zigbee lighting device that sent the scan response message, and receiving a device information response message in response to the device information request message; and
updating table information using device information included in the device information response message, and performing a network initiation procedure with the Zigbee lighting device.

7. The Zigbee lighting control method of claim 6, further comprising:
if a link connection to the Zigbee lighting device has been completed via the network initiation procedure, receiving an ON/OFF state value and a current level value of the Zigbee lighting device from the Zigbee lighting device; and
changing a color of an icon of the Zigbee lighting device to a specific color using the ON/OFF state value and the current level value of the Zigbee lighting device, and displaying a state of the Zigbee lighting device.

8. The Zigbee lighting control method of claim 6, wherein sending the scan request message comprises:
sending the scan request message, and resending the scan request message if the scan response message is not received; and
if a scan response message is not received in response to the resent scan request message, determining that a fault has occurred in the Zigbee lighting device, changing a color of an icon of the Zigbee lighting device to another preset color, and displaying a state of the Zigbee lighting device.

9. A Zigbee lighting control apparatus, comprising:
a display unit for displaying icons respectively indicating states of multiple Zigbee lighting devices;
a touchlink unit for determining whether to perform a Zigbee Light Link (ZLL) touchlink procedure; and
a control unit for controlling Zigbee lighting devices by checking whether a Zigbee switch is in a reset state depending on results of determination by the touchlink unit, performing a broadcast-based link connection on a corresponding Zigbee lighting device based on results of the checking, and performing a unicast-based link connection on remaining Zigbee lighting devices that are not connected via the broadcast-based link connection.

10. The Zigbee lighting control apparatus of claim 9, wherein the control unit is configured to perform a broadcast-based link connection a number of times identical to a number of currently installed Zigbee lighting devices if the Zigbee switch is in the reset state, and to perform a broadcast-based link connection a number of times identical to a preset number of Zigbee lighting devices if the Zigbee switch is not in the reset state.

11. The Zigbee lighting control apparatus of claim 10, wherein the control unit sends a scan request message to the multiple Zigbee lighting devices, receives scan response messages from one or more Zigbee lighting devices that receive the scan request message, selects a Zigbee lighting device, from which a scan response message having a highest received signal strength indication (RSSI) value, from among the scan response messages, is sent, and performs a network initiation procedure with the selected Zigbee lighting device.

12. The Zigbee lighting control apparatus of claim 11, wherein the control unit receives scan response messages from Zigbee lighting devices for which a link connection to the Zigbee switch is not currently established, among Zigbee lighting devices that receives the scan request message.

13. The Zigbee lighting control apparatus of claim 11, wherein the control unit is configured to, if a link connection to the selected Zigbee lighting device has been completed via the network initiation procedure, receive an ON/OFF state value and a current level value of the selected Zigbee lighting device from the selected Zigbee lighting device, change a color of an icon of the selected Zigbee lighting device to a specific color using the ON/OFF state value and the current level value of the selected Zigbee lighting device, and display a state of the Zigbee lighting device.

14. The Zigbee lighting control apparatus of claim 9, wherein the control unit is configured to previously register a network address of each Zigbee lighting device and determine whether the network address is statically mapped to an ID of the Zigbee lighting device; if Zigbee lighting devices that are not connected to a link are present among Zigbee lighting devices, network addresses and IDs of which are mapped to each other, perform a unicast-based link connection a number of times identical to a number of Zigbee lighting devices that are not connected; and if a Zigbee lighting device, a network address and an ID of which are mapped to each other, is not present, determine whether Zigbee lighting devices from which a link is disconnected are present among Zigbee lighting devices that have been previously connected to the link, and perform a unicast-based link connection a number of times identical to a number of Zigbee lighting devices from which the link is disconnected.

15. The Zigbee lighting control apparatus of claim 9, wherein the control unit is configured to send a scan request message using network addresses of the Zigbee lighting devices that are not connected to the link upon performing the unicast-based link connection; receive a scan response message from each Zigbee lighting device that receives the scan request message; and then perform a network initiation procedure with the Zigbee lighting device that sent the scan response message.

16. The Zigbee lighting control apparatus of claim 15, wherein the control unit is configured to, if a link connection to the Zigbee lighting device has been completed via the network initiation procedure, receive an ON/OFF state value and a current level value of the Zigbee lighting device from the Zigbee lighting device, change a color of an icon of the Zigbee lighting device to a specific color using the ON/OFF state value and the current level value of the Zigbee lighting device, and display a state of the Zigbee lighting device.
